(19) United States
(12) Patent Application Publication
(10) Pub. No.: US 2026/0237679 A1
(43) Pub. Date: Aug. 13, 2026

(54) NEGATIVE ELECTRODE BODY AND MANUFACTURING METHOD OF THE SAME

(71) Applicant: TOYOTA JIDOSHA KABUSHIKI KAISHA, Toyota-shi (JP)

(72) Inventors: Tomoyuki UEZONO, Okazaki-shi (JP); Tomohisa Kida, Miyoshi-shi (JP); Nariaki Miki, Okazaki-shi (JP); Minehiro Funato, Toyota-shi (JP)

(73) Assignee: TOYOTA JIDOSHA KABUSHIKI KAISHA, Toyota-shi (JP)

(21) Appl. No.: 19/418,782

(22) Filed: Dec. 12, 2025

(30) Foreign Application Priority Data
Feb. 10, 2025 (JP) 2025-020083

(51) Int. Cl. H01M 4/62; H01M 4/02; H01M 4/04; H01M 4/36; H01M 4/587

(52) U.S. Cl. CPC H01M 4/628; H01M 4/0404; H01M 4/366; H01M 4/587; H01M 2004/027

(57) ABSTRACT

The negative electrode body includes a current collector, and a negative electrode material layer provided on the current collector. The negative electrode material layer includes first active material particles containing a carbon material, second active material particles containing a silicon-based material, the second active material particles being dispersed among the first active material particles, and a sublimable material provided with a void among the first active material particles, the sublimable material being adhered to the second active material particles. The sublimable material is solid under a standard condition and has a property of subliming at a temperature of about 200° C. or lower, under a reduced-pressure condition, or under both.

### CROSS-REFERENCE TO RELATED APPLICATION

This application claims priority to Japanese Patent Application No. 2025-020083 filed on Feb. 10, 2025. The disclosure of the above-identified application, including the specification, drawings, and claims, is incorporated by reference herein in its entirety.

### BACKGROUND

### 1. Technical Field

The technology disclosed in the present specification relates to a negative electrode body of a battery (typically, a non-aqueous secondary battery) and a manufacturing method of the same.

### 2. Description of Related Art

WO 2024/176815 discloses a negative electrode body. The negative electrode body includes a negative electrode material layer provided on a current collector.

The negative electrode material layer contains a negative electrode active material. A carbon material and a silicon-based material are employed as the negative electrode active material.

### SUMMARY

As a negative electrode active material of a battery, a silicon-based material (including silicon single body) has a higher capacity than a carbon material. Therefore, for example, in the field of lithium ion batteries, a silicon-based material as a negative electrode active material has attracted attention. On the other hand, the silicon-based material has a relatively large volume change during charging and discharging. Therefore, in a case where the negative electrode material layer includes the silicon-based material, expansion of the electrode generated during charging is a problem. In the present specification, a novel technology for suppressing the expansion of the electrode in the negative electrode material layer including the silicon-based material is provided.

The technology disclosed in the present specification is embodied in a manufacturing method of a negative electrode body. The manufacturing method includes producing a granule by providing a coating layer containing a sublimable material on a surface of second active material particles containing a silicon-based material, producing a negative electrode material paste by mixing the granule, first active material particles containing a carbon material, a binder, and water, applying the negative electrode material paste onto a surface of a current collector, and providing a void between the sublimable material and the first active material particles by drying the negative electrode material paste applied onto the surface of the current collector to at least partially sublime the coating layer provided on the surface of the second active material particles.

The sublimable material is solid under a standard condition, and has a property of subliming at a temperature of about 200° C. or lower and under a reduced-pressure condition, or at the temperature of about 200° C. or lower or under the reduced-pressure condition.

According to the above configuration, in the negative electrode material paste applied onto the surface of the current collector, the second active material particles containing the silicon-based material are dispersed among the first active material particles containing the carbon material. In addition, the coating layer containing the sublimable material is provided on the surface of the second active material particles, and the coating layer is interposed between the first active material particles and the second active material particles. The sublimable material is solid under a standard condition, and has a property of subliming at a temperature of about 200° C. or lower and under a reduced-pressure condition, or at a temperature of about 200° C. or lower or under a reduced-pressure condition. When the negative electrode material paste having such a structure is dried, the coating layer is at least partially sublimed, so that a void is provided between the sublimable material adhering to the second active material particles, and the first active material particles. That is, a void is provided around the second active material particles. As a result, in the manufactured negative electrode body, even when the second active material particles expand during charging, the expansion of the electrode caused by the expansion of the second active material particles can be suppressed.

In the manufacturing method, a thickness of the coating layer in producing the granule may be 0.5 μm or more and 5 μm or less. This configuration is advantageous in suppressing the expansion of the electrode caused by the expansion of the second active material particles.

The technology disclosed in the present specification is also embodied in a negative electrode body.

The negative electrode body is not particularly limited, but can be manufactured by the manufacturing method.
The negative electrode body includes
a current collector, and
a negative electrode material layer provided on the current collector,
in which the negative electrode material layer includes:
first active material particles containing a carbon material;
second active material particles containing a silicon-based material, the second active material particles being dispersed among the first active material particles; and
a sublimable material provided with a void among the first active material particles, the sublimable material adhering to the second active material particles.
   The sublimable material is solid under a standard condition, and has a property of subliming at a temperature of about 200° C. or lower and under a reduced-pressure condition, or at the temperature of about 200° C. or lower or under the reduced-pressure condition.
   With such a configuration, since a void is present around the second active material particles, even when the second active material particles expand during charging, the expansion of the electrode caused by the expansion of the second active material particles can be suppressed.

In either or both of the negative electrode body and the manufacturing method, the sublimable material may include at least one selected from the group consisting of naphthalene, para-dichlorobenzene, benzoic acid, isophthalic acid, terephthalic acid, anthracene, and 1,4-benzoquinone.

In addition to or instead of the above description, the silicon-based material may include at least one selected from the group consisting of silicon, silicon carbide, silicon monoxide, and a silicon alloy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a negative electrode body;

FIG. 2 is a diagram for describing a manufacturing method of the negative electrode body;

FIG. 3 is a diagram for describing the manufacturing method of the negative electrode body;

FIG. 4 is a diagram for describing the manufacturing method of the negative electrode body;

FIG. 5 is a diagram for describing the manufacturing method of the negative electrode body; and

FIG. 6 is a flowchart showing a series of procedures of the manufacturing method of the negative electrode body.

### DETAILED DESCRIPTION OF EMBODIMENTS

### Configuration of Negative Electrode Body

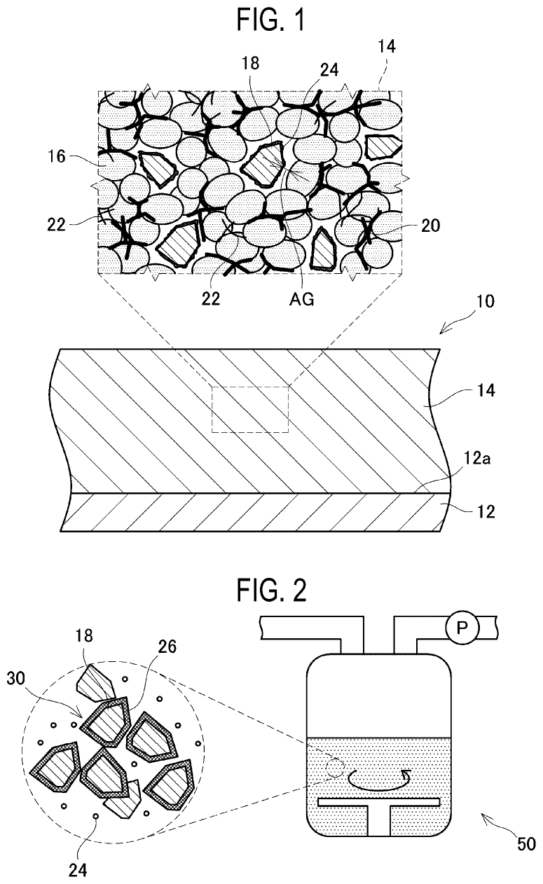

A negative electrode body 10 according to an embodiment will be described with reference to the drawings. The negative electrode body 10 can be used as a negative electrode of a secondary battery such as a lithium ion battery. In particular, the negative electrode body 10 is used in a non-aqueous secondary battery using a non-aqueous electrolyte. As shown in FIG. 1, the negative electrode body 10 includes a current collector 12 and a negative electrode material layer 14. The negative electrode material layer 14 is disposed on a surface 12a of the current collector 12. The negative electrode material layer 14 may be disposed not only on the surface 12a of the current collector 12 but also on a back surface thereof.

The current collector 12 may be a sheet material having conductivity, and may be, for example, a copper foil or a metal foil. In this case, the current collector 12 is not particularly limited, but at least the surface 12a thereof may contain copper. A thickness of the current collector 12 may be a thickness of about 5 μm or more and about 50 μm or less. The current collector 12 may contain a material having conductivity, and may contain a metal other than copper.

FIG. 1 shows a cross-sectional view of the negative electrode body 10 (lower part of FIG. 1) and a diagram schematically showing an internal configuration of the negative electrode material layer 14 (upper part of FIG. 1). As shown in FIG. 1, the negative electrode material layer 14 includes first active material particles 16, second active material particles 18, a sublimable material 24, a binder 20, and a conductive additive 22.

The first active material particles 16 are a main component of the active material of the negative electrode material layer 14. The first active material particles 16 are composed of a carbon material. Examples of the carbon material include graphite, hard carbon, and soft carbon. Typically, the first active material particles 16 are graphite. A particle diameter of the first active material particles 16 may be about 5 μm or more and about 50 μm or less. Here, the “particle diameter” described in the present specification is an average particle diameter, and means a particle diameter (D50) at a cumulative value of 50% in a volume-based particle size distribution measured by a laser diffraction and scattering method.

The second active material particles 18 are used as an active material of the negative electrode material layer 14 together with the first active material particles 16. A content of the second active material particles 18 in the negative electrode material layer 14 is sufficiently lower than a content of the first active material particles 16 in the negative electrode material layer 14, and the second active material particles 18 are dispersed among the first active material particles 16. That is, in the negative electrode material layer 14, the second active material particles 18 are disposed to be surrounded by the first active material particles 16. The second active material particles 18 contain a silicon-based material including silicon. Examples of the silicon-based material include a silicon oxide such as silicon (Si), silicon carbide (SiC), and silicon monoxide (SiO), and a silicon alloy (an alloy containing silicon and another metal such as aluminum (Al), iron (Fe), and manganese (Mn)). Typically, the second active material particles 18 may be silicon carbide. The silicon-based material may contain one kind of material or may contain a plurality of kinds of materials. A particle diameter of the second active material particles 18 may be about 5 μm or more and about 50 μm or less.

The sublimable material 24 adheres to a surface of the second active material particles 18 and provides a void AG between the first active material particles 16. The sublimable material 24 solid under a standard condition and has a property of subliming at a temperature of about 200° C. or lower, under a reduced-pressure condition, or under both. Specifically, the sublimable material 24 may be solid under a standard condition and has a property of subliming at a temperature of about 140° C., under a reduced-pressure condition, or under both. Here, the standard condition means a state of 25° C. (298 K) and 101325 Pa. Examples of the sublimable material 24 include naphthalene, para-dichlorobenzene, benzoic acid, isophthalic acid, terephthalic acid, anthracene, and 1,4-benzoquinone. Typically, the sublimable material 24 may be naphthalene. The sublimable material 24 may be a material that is insoluble in water. The sublimable material 24 may contain one kind of material or may contain a plurality of kinds of materials.

The binder 20 is present between the active material particles 16, 18 and binds the active material particles 16, 18 to each other. Examples of the binder 20 include polyacrylic acid (PAA), polyvinyl alcohol (PVA), polyethylene glycol (PEG), and polyacrylonitrile (PAN). Typically, the binder 20 may be polyacrylic acid. The binder 20 may contain one kind of material or may contain a plurality of kinds of materials.

The conductive additive 22 is dispersed among the active material particles 16 and 18 in the negative electrode material layer 14. Examples of the conductive additive 22 include a carbon material such as carbon nanotubes, carbon black (for example, acetylene black, furnace black, and Ketjen black), coke, and graphite. Typically, for example, it may be a single-walled carbon nanotube. The conductive additive 22 may contain one kind of material or may contain a plurality of kinds of materials. However, in the modification, the negative electrode material layer 14 need not include the conductive additive 22.

### Manufacturing Method of Negative Electrode Body

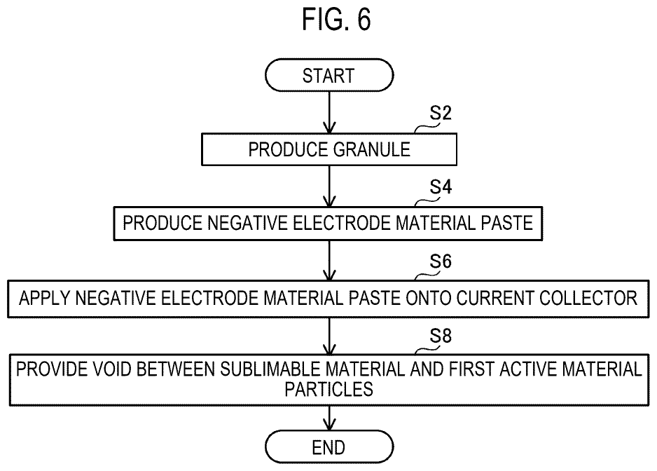

An example of a manufacturing method of the negative electrode body 10 will be described with reference to FIGS. 2 to 6. The negative electrode body 10 can be manufactured according to the flow shown in FIG. 6.

In S2, a step of mixing the second active material particles 18 and the sublimable material 24 to produce a granule 30 is performed. Specifically, as shown in FIG. 2, the granule 30 is produced by providing a coating layer 26 containing the sublimable material 24 on a surface of the second active material particles 18. Although it is an example, as a method for producing the granule 30, a mixer 50 (hereinafter, a granulation method using the mixer 50 is also referred to as a “reduced-pressure stirring drying method”) that performs stirring drying under reduced pressure can be adopted. In this case, the granule 30 may be produced by drying the second active material particles 18 and the sublimable material 24 dissolved in a solvent by stirring and heating under reduced pressure. Typically, the solvent for dissolving the sublimable material 24 may be acetone. However, the solvent for dissolving the sublimable material 24 is not limited to acetone, and may be a solvent in which the sublimable material 24 is dissolved at a high concentration. For example, the solvent for dissolving the sublimable material 24 may be ethanol. In addition, the production of the granule 30 is not limited to the mixer 50, and other types of devices that can be used for coating the particles may be used. For example, a fluidized-bed granulation dryer may be used for the production of the granule 30. In this case, a solution of a sublimable material 24 in a solvent may be sprayed onto the second active material particles 18 in a fluidized bed and then dried to produce granule 30.

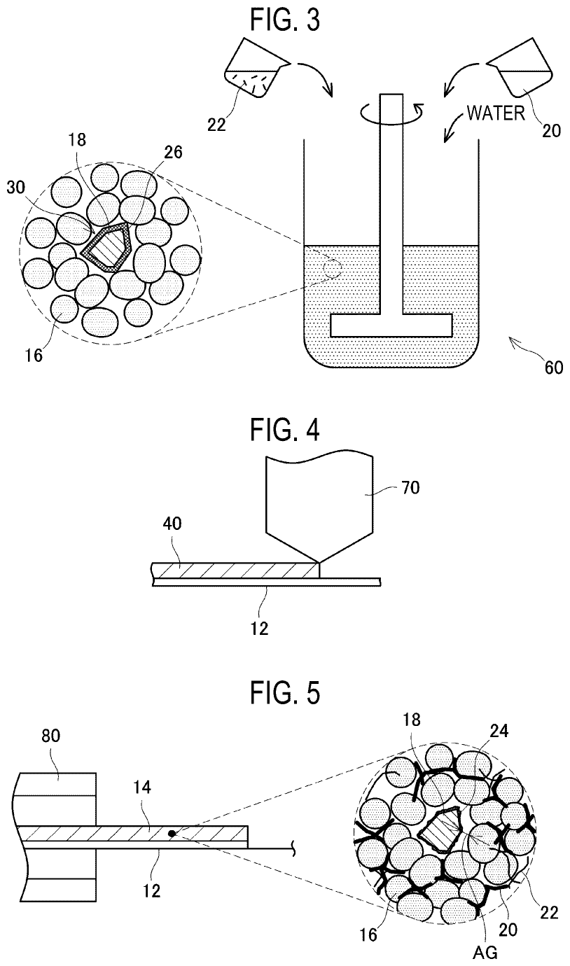

In S4, a step of mixing the granule 30 produced in S2, the first active material particles 16, the binder 20, and water to produce a negative electrode material paste 40 is performed. Specifically, as shown in FIG. 3, first, the granule 30, the first active material particles 16, an aqueous solution of the binder 20, and water are mixed with each other using, for example, a mixer 60. The obtained mixture is further mixed with water, and then a dispersion liquid containing the conductive additive 22 is further mixed therewith to produce the negative electrode material paste 40. In this case, as shown in FIG. 3, the granule 30 is dispersed among the first active material particles 16 in the negative electrode material paste 40.

In S6, as shown in FIG. 4, for example, a step of applying the negative electrode material paste 40 produced in S4 onto the current collector 12 using an applicator 70 is performed.

In S8, a step of forming a void AG between the sublimable material 24 and the first active material particles 16 is performed. Specifically, as shown in FIG. 5, the negative electrode material paste 40 applied to the current collector 12 in S6 is heated and dried in a reduced-pressure drying furnace 80 at about 100° C. or higher and about 200° C. or lower. As a result, the coating layer 26 provided on the surface of the second active material particles 18 is partially sublimed. As a result, in the negative electrode material layer 14, the void AG is provided between the sublimable material 24 and the first active material particles 16. Conditions for subliming the coating layer 26 are not limited to the above. In case of providing the void AG, the reduced pressure may be applied without heating. In the modification, the void AG may be provided without using the reduced-pressure drying furnace 80, and a drying furnace that performs heating and drying at standard pressure (101,325 Pa) may be used. It is not particularly limited, but the negative electrode material paste 40 applied onto the current collector 12 may be pre-dried in, for example, a drying furnace at about 40° C. or higher and 60° C. or lower before the step of providing the void AG. In this case, about 70% or more of the coating layer 26 may remain as the coating layer 26 without subliming after pre-drying before the step of forming the void AG. Further, before the step of providing the void AG, the pre-dried precursor layer of the negative electrode material paste 40 may be compressed using a press roll to adjust the negative electrode material layer 14 to have a predetermined density after pre-drying.

The negative electrode body 10 is manufactured by the above steps. In the negative electrode material paste 40 applied to the surface of the current collector 12, the second active material particles 18 containing a silicon-based material are dispersed among the first active material particles 16 containing a carbon material. In addition, the coating layer 26 containing the sublimable material 24 is provided on the surface of the second active material particles 18, and the coating layer 26 is interposed between the first active material particles 16 and the second active material particles 18. The sublimable material 24 solid under a standard condition and has a property of subliming at a temperature of about 200° C. or lower, under a reduced-pressure condition, or under both. When the negative electrode material paste 40 having such a structure is dried, the coating layer 26 is partially sublimed, thereby providing a void AG between the sublimable material 24 adhered to the second active material particles 18 and the first active material particles 16. That is, a void is provided around the second active material particles 18. As a result, even when the second active material particles 18 expand during charging, the expansion of the electrode (that is, the negative electrode body 10) caused by the expansion of the second active material particles 18 can be suppressed.

In the negative electrode material layer 14, about 100 to 1,000 ppm of the sublimable material 24 remains without sublimation. The presence of the sublimable material 24 in the negative electrode material layer 14 can be confirmed by, for example, gas chromatography.

Although it is an example, a thickness of the coating layer 26 is about 0.5 μm or more and about 5.0 μm or less. Preferably, the thickness of the coating layer 26 may be about 1.0 μm or more and about 3.0 μm or less. When the coating layer 26 is within the thickness range, it is advantageous in suppressing the expansion of the negative electrode body 10 caused by the expansion of the second active material particles 18. However, in the modification, the thickness of the coating layer 26 may be about 0.2 μm or more, or the thickness of the coating layer 26 may be about 8 μm or less. Here, the thickness of the coating layer 26 is calculated from a particle diameter (D50) of the second active material particles 18 and a particle diameter (D50) of the granule 30. Specifically, the thickness of the coating layer 26 is obtained by dividing a difference between the particle diameter (D50) of the granule 30 and the particle diameter (D50) of the second active material particles 18 by 2.

Next, Embodiments according to the present technology will be described with reference to Table 1. However, the following description is not intended to limit the configuration according to the present technology. First, the negative electrode bodies 10 of Embodiments 1 to 12 and the negative electrode body of the comparative example were produced.

### Negative Electrode Body of Embodiment 1

The negative electrode body 10 of Embodiment 1 was produced according to the manufacturing method. Graphite was used as the first active material particles 16. Silicon carbide was used as the second active material particles 18. Naphthalene was used as the sublimable material 24. The sublimable material 24 was dissolved in acetone in advance, and a solution in which the sublimable material 24 was adjusted to 20% by mass in the acetone solution was used as a sublimable material solution. Polyacrylic acid (PAA) was used as the binder 20, and a PAA aqueous solution was used as a binder solution. A single-walled carbon nanotube (SWCNT) was used as the conductive additive 22. As the conductive additive dispersion liquid, a 0.4% by mass dispersion liquid of SWCNT was used. The first active material particles 16 and the second active material particles 18 were blended such that a mass ratio of the first active material particles 16 to the second active material particles 18 was 80/20.

In the step (S2 in FIG. 6) of producing the granule 30, the second active material particles 18 and the sublimable material solution were mixed by the reduced-pressure stirring drying method. As a result, the granule 30 was produced. In the present embodiment, the thickness of the coating layer 26 of the granule 30 was 0.25 μm.

In the step (S4 in FIG. 6) of producing the negative electrode material paste 40, first, the first active material particles 16, the binder solution, and water were added to the produced granule 30, and the mixture was mixed using a mixer. Next, water was further added to the obtained mixture and mixed, and then the conductive additive dispersion liquid was added thereto and mixed. As a result, the negative electrode material paste 40 was produced.

In the step of applying the negative electrode material paste 40 (S6 in FIG. 6), the negative electrode material paste 40 was applied onto the current collector 12 using an applicator. A copper foil (thickness: 8 μm) was used as the current collector 12.

In the step (S8 in FIG. 6) of providing the void AG, first, the negative electrode material paste 40 applied onto the current collector 12 was pre-dried using a drying furnace at 50° C. Next, the obtained pre-dried precursor layer was compressed using a roll press, and the density of the finally obtained negative electrode material layer 14 was adjusted to 1.0 g/cm³. Finally, the compressed precursor layer was dried using a reduced-pressure drying furnace at 140° C. As a result, in the negative electrode material layer 14, the sublimable material 24 of the coating layer 26 was partially sublimed, and the void AG was provided between the sublimable material 24 and the second active material particles 18. In the negative electrode material layer 14, a mass ratio of the negative electrode active material/conductive additive/dispersant/binder was 97.75/0.10/0.15/2.00. The mass of the dispersant refers to the mass of the dispersant contained in the SWCNT dispersion liquid of the conductive additive 22. A single-side areal loading of the negative electrode material layer 14 on the current collector 12 was 7.3 mg/cm².

### Negative Electrode Bodies of Embodiments 2 to 9

In the step of producing the granule 30 of Embodiments 2 to 6, the same naphthalene as in Embodiment 1 was used as the sublimable material 24. In the step of producing the granule 30 of Embodiments 2 to 6, the coating layers 26 having thicknesses of 0.5 μm, 1.0 μm, 3.3 μm, 5.0 μm, and 7.5 μm were provided instead of the coating layer 26 having a thickness of 0.25 μm in Embodiment 1. In the step of producing the granule 30 of Embodiments 7 to 12, para-dichlorobenzene was used as the sublimable material instead of the naphthalene of Embodiments 1 to 6. In addition, in the step of producing the granule 30 of Embodiments 7 to 12, the coating layers 26 having thicknesses of 0.25 μm, 0.5 μm, 1.0 μm, 3.3 μm, 5.0 μm, and 7.5 μm were provided. The thickness of the coating layer 26 was adjusted by changing the mass of the sublimable material 24. The negative electrode body 10 was produced by the same manufacturing method as that of Embodiment 1 for the other steps.

### Negative Electrode Body of Comparative Example

The negative electrode body of the comparative example was produced as follows. The types and mass ratios of the raw materials used were the same as in Embodiment 1. First, the first active material particles 16 and the second active material particles 18, the binder solution, and water were mixed using a mixer. Thereafter, the binder solution was further added to the obtained mixture, and then the conductive additive dispersion liquid was mixed therewith to produce a negative electrode material paste. That is, in the comparative example, the negative electrode material paste was produced by omitting the step of producing the granule 30. Next, the same step of applying the negative electrode material paste 40 as in Embodiment 1 was performed. Next, the applied negative electrode material paste 40 was dried using a drying furnace at 100° C. Finally, the negative electrode material layer 14 that had been dried was compressed using a roll press, and the density of the negative electrode material layer 14 was adjusted to 1.0 g/cm³. The single-side areal loading of the negative electrode material layer on the current collector 12 was 7.3 mg/cm² as in Embodiment 1.

### Positive Electrode Body

The same positive electrode body was used for Embodiments 1 to 12 and the comparative example. Lithium nickel cobalt manganese oxide (NCM, manufactured by Sumitomo Metal Mining Co., Ltd.) was used as the positive electrode active material. Acetylene black (manufactured by Denka Company Limited., “Li-435”) was used as the conductive material. Polyvinylidene fluoride (PVdF) was used as the binder, and a 5% by mass N-methyl-2-pyrrolidone (NMP) solution of PVdF (manufactured by KBMJ, “#7305”) was used as the binder solution.

First, the positive electrode active material, the conductive material, and the binder solution were mixed using a mixer. The binder solution was further added to the obtained mixture to produce a positive electrode material paste. Next, the obtained positive electrode material paste was applied onto a current collector using an applicator. An aluminum foil (thickness: 12 μm) was used as the current collector. The positive electrode material paste applied onto the current collector was dried using a drying furnace at 120° C. As a result, a positive electrode body including a positive electrode material layer was produced. In the positive electrode material layer, a mass ratio of the positive electrode active material/conductive material/binder was 95/2.5/2.5. A single-side areal loading of the positive electrode material layer on the current collector was 19.5 mg/cm². Finally, the positive electrode material layer was compressed using a roll press, and the density of the positive electrode material layer was adjusted to be 3.1 g/cm³.

### Production of Battery Cell

The negative electrode body 10 of Embodiment 1 and the positive electrode body were laminated with a separator interposed therebetween, and a non-aqueous electrolytic solution was introduced into the obtained laminate to produce a laminated battery cell. Battery cells were also produced in the same manner for the negative electrode bodies 10 of Embodiments 2 to 12 and the negative electrode body of the comparative example.

### Evaluation of Battery Cell

For each of the produced battery cells, an initial direct-current internal resistance (DCIR) value, a capacity retention, and a cycle swelling ratio were evaluated. The evaluation results are shown in Table 1. The capacity retention here is a ratio of the full charge capacity after 100 cycles of charging and discharging at a rate of 0.5C to the initial full charge capacity, where the full charge capacity of the battery after 100 cycles of charging and discharging at a rate of 0.5C is measured. In addition, in the measurement of the cycle swelling ratio, a contact type displacement meter was installed on the battery cell, and a displacement amount of the thickness of the battery cell during a plurality of cycles (for example, several tens of cycles) of charging and discharging was measured. The cycle swelling ratio is a ratio of the displacement amount of the thickness of the battery cell during the plurality of cycles to the thickness of the initial battery cell.

The initial DCIR value, the capacity retention, and the cycle swelling ratio measured in each battery cell are shown in Table 1. In Table 1, the measurement results were described as “Good” as “O”, “Fair” as “O”, and “Poor” as “X” as the performance of the battery. In the initial DCIR value, in a case where the measurement result was 2Ω or less, it was determined to be “fair”, and in a case where the measurement result exceeded 2Ω, it was determined to be “poor”. In the capacity retention, in a case where the measurement result was 90% or more, it was determined to be “fair”, and in a case where the measurement result was less than 90%, it was determined to be “poor”. In the cycle swelling ratio, the lower the measurement result, the higher the performance as a battery, and it was determined to be “good” in a case of less than 2.5%, “fair” in a case of 2.5% or more and less than 3%, and “poor” in a case of 3% or more, respectively.

TABLE 1

| | | Thickness | | | | | Cycle | | |
|---|---|---|---|---|---|---|---|---|---|
| | | of coating | Initial | | Capacity | | swelling | | |
| | Sublimable | layer | DCIR | | retention | | ratio | | Total |
| | material | (μm) | (Ω) | Evaluation | (%) | Evaluation | (%) | Evaluation | evaluation |
| Embodiment | Naphthalene | 0.25 | 1.56 | ◯ | 92 | ◯ | 3.1 | X | X |
| 1 | | | | | | | | | |
| Embodiment | Naphthalene | 0.5 | 1.52 | ◯ | 91 | ◯ | 2.7 | ◯ | ◯ |
| 2 | | | | | | | | | |
| Embodiment | Naphthalene | 1.0 | 1.55 | ◯ | 92 | ◯ | 2.1 | ⊚ | ⊚ |
| 3 | | | | | | | | | |
| Embodiment | Naphthalene | 3.0 | 1.60 | ◯ | 92 | ◯ | 2.6 | ◯ | ◯ |
| 4 | | | | | | | | | |
| Embodiment | Naphthalene | 5.0 | 1.71 | ◯ | 90 | ◯ | 2.6 | ◯ | ◯ |
| 5 | | | | | | | | | |
| Embodiment | Naphthalene | 7.5 | 2.44 | X | 86 | X | 2.5 | ◯ | X |
| 6 | | | | | | | | | |
| Embodiment | Para- | 0.25 | 1.59 | ◯ | 91 | ◯ | 3.2 | X | X |
| 7 | dichlorobenzene | | | | | | | | |
| Embodiment | Para- | 0.5 | 1.57 | ◯ | 91 | ◯ | 2.9 | ◯ | ◯ |
| 8 | dichlorobenzene | | | | | | | | |
| Embodiment | Para- | 1.0 | 1.58 | ◯ | 92 | ◯ | 2.3 | ⊚ | ⊚ |
| 9 | dichlorobenzene | | | | | | | | |
| Embodiment | Para- | 3.0 | 1.55 | ◯ | 92 | ◯ | 2.3 | ⊚ | ⊚ |
| 10 | dichlorobenzene | | | | | | | | |
| Embodiment | Para- | 5.0 | 1.61 | ◯ | 92 | ◯ | 2.5 | ◯ | ◯ |
| 11 | dichlorobenzene | | | | | | | | |
| Embodiment | Para- | 7.5 | 2.53 | ◯ | 84 | X | 2.8 | ◯ | X |
| 12 | dichlorobenzene | | | | | | | | |
| Comparative | — | — | 1.50 | ◯ | 92 | ◯ | 3.2 | X | X |
| Example | | | | | | | | | |

⊚: Good,
◯: Fair,
X: Poor

### Embodiments 1 to 6

As described above, in the negative electrode bodies 10 of Embodiments 1 to 6, naphthalene was used as the sublimable material. The evaluation results of the battery cells using the negative electrode bodies 10 of Embodiments 1 to 6 will be compared below.

In the battery cells using the negative electrode bodies 10 of Embodiments 2 to 5, the initial DCIR value was 1.52 to 1.71 Q, and the capacity retention was 90% to 92%, and the determination was “Fair” in both cases. In addition, in the battery cells using the negative electrode bodies 10 of Embodiments 2 to 5, the cycle swelling ratio was 2.0% to 2.7%, and the determination was “Fair” or more, exhibiting favorable performance. Accordingly, when the thickness of the coating layer 26 is 0.5 μm or more and 5.0 μm or less, the expansion of the second active material particles 18 is absorbed by the contraction of the coating layer 26. It was confirmed that the expansion of the electrode (that is, the negative electrode body 10 in a case of being used as a battery electrode) caused by the expansion of the second active material particles 18 could be suppressed. In particular, the cycle swelling ratios of the battery cells using the negative electrode bodies 10 of Embodiments 3 and 4 were 2.1% and 2.0%, and the determination was “Good”. Accordingly, it was confirmed that, when the thickness of the coating layer 26 is 1.0 μm or more and 3.0 μm or less, it is relatively advantageous in suppressing the expansion of the electrode.

However, in the battery cell using the negative electrode body 10 of Embodiment 1, the initial DCIR value (1.56Ω) and the capacity retention (92%) were determined to be “Fair”, but the cycle swelling ratio (3.2%) was determined to be “Poor”. It is considered to be because, when the thickness of the coating layer 26 was as small as 0.25 μm, the void AG provided in the negative electrode body 10 was also small, and the effect on suppression of the expansion of the electrode was not observed.

In addition, in the battery cell using the negative electrode body 10 of Embodiment 6, the cycle swelling ratio (2.5%) was determined to be “Fair”, but both the initial DCIR value (2.44Ω) and the capacity retention (86%) were determined to be “Poor”. It is considered to be because, when the thickness of the coating layer 26 was as large as 7.5 μm, the void AG provided in the negative electrode body 10 was also large, and the conductive path was not sufficiently provided between the first active material particles 16 and the second active material particles 18.

### Embodiments 7 to 12

As described above, in the negative electrode bodies 10 of Embodiments 7 to 12, para-dichlorobenzene was used as the sublimable material. The evaluation results of the battery cells using the negative electrode bodies 10 of Embodiments 7 to 9 will be respectively compared below.

In the battery cells using the negative electrode bodies 10 of Embodiments 8 to 11, the initial DCIR value was 1.57 to 1.61Ω, and the capacity retention was 91% to 92%, and the determination was “Fair” in both cases. In addition, in the battery cells using the negative electrode bodies 10 of Embodiments 8 to 11, the cycle swelling ratio was 2.3% to 2.9%, and the determination was “Fair” or more, exhibiting favorable performance. From this, it was confirmed that, when the thickness of the coating layer 26 was 0.5 μm or more and 5.0 μm or less, the expansion of the second active material particles 18 was absorbed by the contraction of the coating layer 26, and the expansion of the electrode caused by the expansion of the second active material particles 18 could be suppressed. In particular, the cycle swelling ratios of the battery cells using the negative electrode bodies 10 of Embodiments 9 and 10 were both 2.3%, and the determination was “Good”. Accordingly, it was confirmed that, when the thickness of the coating layer 26 is 1.0 μm or more and 3.0 μm or less, it is relatively advantageous in suppressing the expansion of the electrode.

However, in the battery cell using the negative electrode body 10 of Embodiment 7, the initial DCIR value (1.59Ω) and the capacity retention (91%) were determined to be “Fair”, but the cycle swelling ratio (3.2%) was determined to be “Poor”. It is considered to be because, when the thickness of the coating layer 26 was as small as 0.25 μm, the void AG around the second active material particles 18 in the negative electrode body 10 was also small, and the effect of suppressing the expansion of the electrode was not observed.

In addition, in the battery cell using the negative electrode body 10 of Embodiment 12, the cycle swelling ratio (2.8%) was determined to be “Fair”, but both the initial DCIR value (2.53Ω) and the capacity retention (84%) were determined to be “Poor”. It is considered to be because, when the thickness of the coating layer 26 was as large as 7.5 μm, the void AG provided in the negative electrode body 10 was also large, and the conductive path was not sufficiently provided between the first active material particles 16 and the second active material particles 18.

From the above, in Embodiments 7 to 12 of the negative electrode body 10 using para-dichlorobenzene as the sublimable material 24, the same tendency as in Embodiments 1 to 6 of the negative electrode body 10 using naphthalene as the sublimable material 24 was obtained in terms of the thickness of the coating layer 26 of the granule 30. That is, the thickness of the coating layer 26 is controlled to be 0.5 μm or more and 5.0 μm or less, preferably 1.0 μm or more and 3.0 μm or less, regardless of the type of the sublimable material 24. It was confirmed that the expansion of the electrode caused by the expansion of the second active material particles 18 during charging was greatly affected.

### COMPARATIVE EXAMPLE

As described above, in the manufacturing method of the negative electrode body of the comparative example, the negative electrode material paste was produced by omitting the step of producing the granule 30 on which the coating layer 26 was provided. In the battery cell using the negative electrode body of the comparative example, the initial DCIR value (1.50Ω) and the capacity retention (92%) were determined to be “Fair”. On the other hand, in the battery cell using the negative electrode body of the comparative example, the cycle swelling ratio (3.2%) was determined to be “Poor”. It is considered that, in the negative electrode body of the comparative example, since the void was not present around the second active material particles 18, the electrode expanded due to the expansion of the second active material particles 18.

What is claimed is:

1. A negative electrode body comprising:
a current collector; and
a negative electrode material layer provided on the current collector,
wherein the negative electrode material layer includes:
first active material particles containing a carbon material;
second active material particles containing a silicon-based material, the second active material particles being dispersed among the first active material particles; and
a sublimable material provided with a void among the first active material particles, the sublimable material adhering to the second active material particles; and
the sublimable material is solid under a standard condition, and has a property of subliming at a temperature of about 200° C. or lower and under a reduced-pressure condition, or at the temperature of about 200° C. or lower or under the reduced-pressure condition.

2. The negative electrode body according to claim 1, wherein the sublimable material includes at least one selected from the group consisting of naphthalene, para-dichlorobenzene, benzoic acid, isophthalic acid, terephthalic acid, anthracene, and 1,4-benzoquinone.

3. The negative electrode body according to claim 1, wherein the silicon-based material includes at least one selected from the group consisting of silicon, silicon carbide, silicon monoxide, and a silicon alloy.

4. A manufacturing method of a negative electrode body, the manufacturing method comprising:
producing a granule by providing a coating layer containing a sublimable material on a surface of second active material particles containing a silicon-based material;
producing a negative electrode material paste by mixing the granule, first active material particles containing a carbon material, a binder, and water;
applying the negative electrode material paste onto a surface of a current collector; and
providing a void between the sublimable material and the first active material particles by drying the negative electrode material paste applied onto the surface of the current collector to at least partially sublime the coating layer provided on the surface of the second active material particles,
wherein the sublimable material is solid under a standard condition, and has a property of subliming at a temperature of about 200° C. or lower and under a reduced-pressure condition, or at the temperature of about 200° C. or lower or under the reduced-pressure condition.

5. The manufacturing method according to claim 4, wherein a thickness of the coating layer in the producing the granule is 0.5 μm or more and 5 μm or less.
